(19) United States
(12) Patent Application Publication
(10) Pub. No.: US 2012/0257503 A1
(43) Pub. Date: Oct. 11, 2012

(54) INTELLIGENT PRESENCE CONGESTION NOTIFICATION SERVICE

(75) Inventors: Mira Vrbaski, Kanata (CA); Cory R. Weppler, Ottawa (CA); Sankaranarayanan Sathyanarayan, Stewartsville, NJ (US); Colin L. Kahn, Morris Plains, NJ (US)

(73) Assignees: Alcatel Lucent USA Inc., Murray Hill, NJ (US); Alcatel-Lucent Canada Inc., Ottawa (CA)

(21) Appl. No.: 13/083,871

(22) Filed: Apr. 11, 2011

(51) Int. Cl. H04W 24/04

(52) U.S. Cl. 370/235

(57) ABSTRACT

Various exemplary embodiments relate to a method performed by a network platform, the method including: receiving a subscriber ID and associated base station ID for a user equipment; receiving a congestion alert event message; identifying a user equipment on a congested base station; and notifying the user equipment on the congested base station.

### TECHNICAL FIELD

Various exemplary embodiments disclosed herein relate generally to congestion in telecommunications networks.

### BACKGROUND

As the demand increases for varying types of applications within mobile telecommunications networks, service providers must constantly upgrade their systems in order to reliably provide this expanded functionality. This increased functionality along with an increased number of users leads to congested base stations.

### SUMMARY

In mobile telecommunication systems user equipment (UE) has a limited ability to determine if the base station to which it is connected is congested. The UE is able to determine the throughput capability available, but this can vary due to various factors, for example, the distance to the base station or base station antenna gain, which may not be not known to the UE. Accordingly, it would be desirable to provide the UE with congestion information to allow the UE to switch to another base station or network, or to otherwise alter its behavior.

In light of the present need for the identification of base station congestion and a method for notifying UE of this congestion, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed bra network platform, the method including: receiving a subscriber ID and associated base station ID for a user equipment; receiving a congestion alert event message; identifying a user equipment on a congested base station; and notifying the user equipment on the congested base station.

A further exemplary embodiment relates to congestion notification system for a wireless communication system, including: a network congestion monitoring element that produces a congestion alert event message; a network platform that receives the congestion alert event message from the network congestion monitoring element and that receives a subscriber ID and an associated base station ID for a user equipment; wherein the network platform is configured to send a congestion message to a user equipment.

A further exemplary embodiment relates to machine-readable storage medium encoded with instructions for managing base station congestion for a user equipment, the machine-readable storage medium including: instructions for a subscriber ID and associated base station ID for a user equipment; instructions for receiving a congestion alert event message; instructions for identifying a user equipment on a congested base station; and instructions for notifying the user equipment on the congested base station.

Various embodiments may be further adapted wherein the congestion alert event message includes a congestion level indicator.

Various embodiments may be further adapted wherein notifying the user equipment includes the congestion level indicator.

Various embodiments may further include identifying available base stations adjacent to the congested base station.

Various embodiments may be further adapted wherein notifying user equipment includes sending the user equipment a message including a list of adjacent available base stations.

Various embodiments may be further adapted wherein the list of adjacent available base stations includes congestion information for the available base stations.

Various embodiments may further include storing the subscriber ID and associated base station ID for the user equipment in a database.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services; and

FIG. 2 illustrates an exemplary method for notifying user equipment of base station congestion.

### DETAILED DESCRIPTION

Referring now to the drawings, in which like numerals refer to like components or steps, there are disclosed broad aspects of various exemplary embodiments.

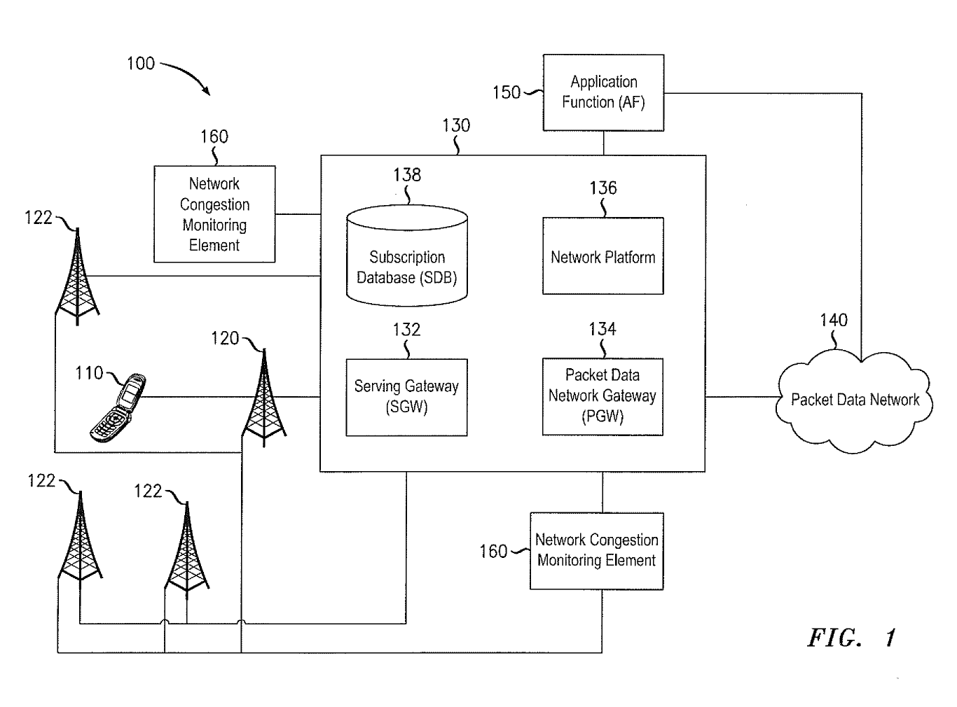

FIG. 1 illustrates an exemplary subscriber network 100 for providing various data services. Exemplary subscriber network 100 may be telecommunications network or other network for providing access to various services. Exemplary subscriber network 100 may include user equipment 110, base station 120, adjacent base stations 122, packet core network 130, packet data network 140, application node (AN) 150, and network congestion monitoring element 160.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, television set-top box, or any other device capable of communicating with other devices via packet core network 130.

Base station 120 may be a device that enables communication between user equipment 110 and packet core network 130. For example, base station 120 may be a base transceiver station such as an evolved nodeB (eNodeB) as defined by 3GPP standards. The base station 120 may also be part of a GPRS/EDGE network, a WCDMA network, a 3G1X/EV-DO network, a HSPA/HSPA+ network, or another wireless communication network. Thus, base station 120 may be a device that communicates with user equipment 110 via a first medium, such as radio waves, and communicates with packet core network 130 via a second medium, such as Ethernet cable. Base station 120 may be in direct communication with packet core network 130 or may communicate via a number of intermediate nodes (not shown). In various embodiments, multiple adjacent base stations 122 may also be present to provide mobility to user equipment 110.

Packet core network 130 may be a device or network of devices that provides user equipment 110 with gateway access to packet data network 140. Packet core network 130 may further charge a subscriber for use of provided data services and ensure that particular quality of experience (QoE) standards are met. Thus, packet core network 130 may be implemented, at least in part, according to the 3GPP TS 29.212, 29.213, 29.214, 23.401, and 23.402 standards among others. The packet core network 130 may additionally or alternatively be implemented according to other standards as well. Accordingly, packet core network 130 may include a serving gateway (SGW) 132, a packet data network gateway (PGW) 134, network platform 136, and a subscription database (SDB) 138.

Serving gateway (SGW) 132 may be a device that provides gateway access to the packet core network 130. SGW 132 may be the first device within the packet core network 130 that receives packets sent by user equipment 110. SGW 132 may forward such packets toward PGW 134. SGW 132 may perform a number of functions such as, for example, managing mobility of user equipment 110 between multiple base stations, such as base stations 120, 122, and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, packet core network 130 may include multiple SGWs (not shown) and each SGW may communicate with multiple base stations (not shown).

Packet data network gateway (PGW) 134 may be a device that provides gateway access to packet data network 140. PGW 134 may be the final device within the packet core network 130 that receives packets sent by user equipment 110 toward packet data network 140 via SGW 132. PGW 134 may include a number of additional features such as, for example, packet filtering, deep packet inspection, and subscriber charging support. PGW 134 may also be responsible for requesting resource allocation for unknown application services.

The network platform 136 may be a device that receives requests for application services, generates rules and policies regarding the operation of the packet core network 130. The network platform 136 may also be in communication with SGW 132 and PGW 134. The network platform 136 may also receive base station congestion information. The network platform 136 may be or include a policy and charging rules node (PCRN).

Subscription database (SDB) 138 may be a device that stores information related to subscribers to the subscriber network 100. Thus, SDB 138 may include a machine-readable storage medium such as read-only memory (ROM), random-access memory (RAM), magnetic disk storage media, optical storage media, flash-memory devices, and/or similar storage media. SDB 138 may be a component of network platform 136 or may constitute an independent node within packet core network 130. Data stored by SDB 138 may include an identifier of each subscriber, an ID for an associated base station, and indications of subscription information for each subscriber such as bandwidth limits, charging parameters, and subscriber priority.

Packet data network 140 may be any network for providing data communications between user equipment 110 and other devices connected to packet data network 140, such as AN 150. Packet data network 140 may further provide, for example, phone and/or Internet service to various user devices in communication with packet data network 140.

Application node (AN) 150 may be a device that provides a known application service to user equipment 110. Thus, AN 150 may be a server or other device that provides, for example, a video streaming or voice communication service to user equipment 110. AN 150 may further be in communication with the network platform 136 of the packet core network 130. When AN 150 is to begin providing known application service to user equipment 110, AN 150 may generate an application request message to notify the network platform 136 that resources should be allocated for the application service. This application request message may include information such as an identification of the subscriber using the application service and an identification of the particular service data flows that must be established in order to provide the requested service. AN 150 may communicate such an application request to the platform network 136.

The network congestion monitoring element 160 may analyze the network capacity and usage of the base stations 120, including the capacity available on the air-interface between the base station 120 and the user equipment 110. If the base station 120 reaches a predetermined level of congestion, then the network congestion monitoring element 160 may provide a congestion alert event message to the network platform 136. The congestion alert event message may further include a congestion level indication that may provide an indication as to the severity of the congestion at the base station 120, in addition, the message may contain a list of UEs/IPs that are contributing to the congestion. The network congestion monitoring element 160 may be implemented as software on a server or other processor, as a router, as a gateway, or as any other hardware or software capable of providing this functionality.

Having described the components of subscriber network 100, a brief summary of the operation of subscriber network 100 will be provided. It should be apparent that the following description is intended to provide an overview of the operation of subscriber network 100 and is therefore a simplification in some respects.

According to various exemplary embodiments, user equipment 110 may communicate with network platform 136 to provide a base station ID for the base station 160 currently connected to the UE 110. The network platform 136 may then store the base station ID associated with the UE 110 and subscriber ID in the SDB 138. The base station ID and subscriber ID associated with the UE 110 may also be provided by other network equipment and stored in the SDB 138.

The network congestion monitoring element 160 may monitor the traffic at the base station 120 to determine if the base station 120 is congested. The network congestion monitoring element 160 may use various methods and parameters to identify congestion at the base station 120, for example used or available bandwidth. When the congestion exceeds a threshold value, the congestion monitoring element 160 may send a congestion alert event message to the network platform 136 to indicate that the base station 120 is congested. Further, the network congestion monitoring element 160 may determine a level of congestion present based upon predetermined criteria and provide a congestion level indication in the congestion alert event message. Furthermore, the network congestion monitoring element 160 may report a list of subscriber/UEs that are contributing to the congestion, including a full list or delta list from previous notifications as well as other description characteristics of the congested network element.

When the network platform 136 receives the congestion alert event message, the network platform 136 determines if any subscribers found in the SDB 138 are currently using the congested base station 120. The network platform 136 may notify the UE 110 associated with the subscriber that the base station 120 that the UE 110 is using is congested along with the congestion level indication in a congestion notification message.

The UE then may receive the congestion notification message and may determine if the congestion is significant enough to warrant the UE connecting to another nearby base station 122 that may be less congested. Alternatively the UE may decide to reduce the amount of data it is sending/receiving via the network so as to reduce the level of congestion. This determination may use various parameters and may also consider the current state of the UE, for example, standby, data transmit, file download, voice call, etc. For example, if the UE is in standby there may not be sufficient reason to connect to another base station 122, but for a voice call or certain types of higher priority data it may be necessary to switch to a nearby base station 122 in order to achieve the necessary performance for the voice call or the higher priority data. The UE 110 may implement this functionality with client software that may be installed on the UE 110. This client software then may communicate with the network platform 136 to implement the capability to identify base station 120 congestion and then may switch to another less congested base station 122, or adapt its transmission and reception of data accordingly. Further, the client software may include configuration parameters to allow the user of the UE to control the response to base station congestion.

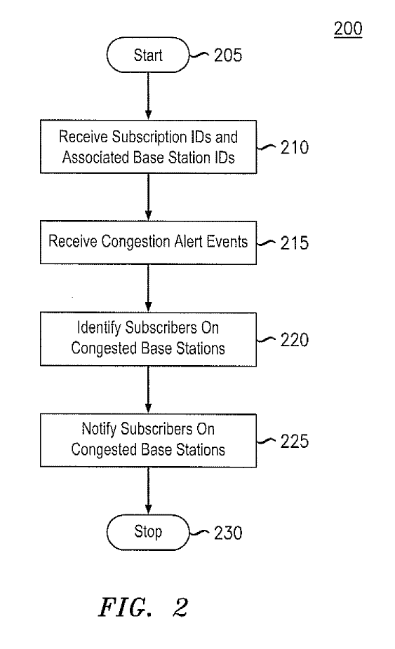

FIG. 2 illustrates an exemplary method for notifying user equipment of base station congestion. This method may be carried out by the network platform 136, or may be implemented elsewhere within the subscriber network 100. Further, the network platform 136 may be found elsewhere in the subscriber network 100 outside of the packet core network 130. The method may begin at step 205 and proceeds to step 210, where the network platform 136 may receive subscriber IDs and associated base station IDs from the UE 110. In step 215, the network platform 136 may receive congestion alert events from the network congestion monitoring element 160. Steps 210 and 215 may occur in any order or simultaneously.

When the network platform 136 receives congestion alert events, the network platform 136 then may identify subscribers on the congested base stations 220. This may easily be done by searching the SDB 138 to determine the subscribers connected to the congested base station 120. Next, the network platform 225 may notify the subscribers on the congested base stations 120 of the congestion. Then the method may end at step 230. It should be noted that many of these functions may take place as well in the network congestion monitoring unit 160, as it may have a list of UEs associated with the base station.

Because the network platform 136 receives congestion alert event messages for all the base stations 110, the network platform 136 may also identify adjacent base stations 122 adjacent to the congested base station 110. The network platform 136 may send a list of these adjacent base stations and their congestion status to the UE 110. The UE 110 may then use this additional information to identify an adjacent base station to connect to when the base station 110 is congested. It is also possible, that the UE 110 may chose to connect to another type of wireless network when the base station 110 is congested.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a network platform, the method comprising:
receiving a subscriber ID and associated base station ID for a user equipment;
receiving a congestion alert event message;
identifying a subscriber on a congested base station; and
notifying the user equipment on the congested base station.

2. The method of claim 1, wherein the congestion alert event message includes a congestion level indicator.

3. The method of claim 2, wherein notifying the user equipment includes the congestion level indicator.

4. The method of claim 1, further comprising identifying available base stations adjacent to the congested base station.

5. The method of claim 4, wherein notifying user equipment includes sending the user equipment a message including a list of adjacent available base stations.

6. The method of claim 5, wherein the list of adjacent available base stations includes congestion information for the available base stations.

7. The method of claim 1, further comprising storing the subscriber ID and associated base station ID for the user equipment in a subscription database.

8. A congestion notification system for a wireless communication system, comprising:
a network congestion monitoring element that produces a congestion alert event message;
a network platform that receives the congestion alert event message from the network congestion monitoring element and that receives a subscriber ID and an associated base station ID for a user equipment;
wherein the network platform is configured to send a congestion message to a user equipment.

9. The system of claim 8, the congestion alert event message includes a congestion level indicator.

10. The system of claim 9, wherein the congestion message includes the congestion level indicator.

11. The system of claim 8, wherein the network platform is configured to identify available base stations adjacent to a congested base station.

12. The system of claim 11, wherein the congestion message includes a list of adjacent available base stations.

13. The system of claim 12, wherein the list of adjacent available base stations includes congestion information for the available base stations.

14. The method of claim 8, further comprising a subscription database where the subscriber ID and associated base station ID are stored.

15. A machine-readable storage medium encoded with instructions for managing base station congestion for a user equipment, the machine-readable storage medium comprising:
instructions for a subscriber ID and associated base station ID for a user equipment;
instructions for receiving a congestion alert event message;
instructions for identifying a user equipment on a congested base station; and
instructions for notifying the user equipment on the congested base station.

16. The machine-readable storage medium of claim 15, wherein the congestion alert event message includes a congestion level indicator.

17. The machine-readable storage medium of claim 16, wherein the instructions for notifying the user equipment includes the congestion level indicator.

18. The machine-readable storage medium of claim 15, further comprising instructions for identifying available base stations adjacent to the congested base station.

19. The machine-readable storage medium of claim 18, wherein the instructions for notifying user equipment includes instructions for sending the user equipment a message including a list of adjacent available base stations.

20. The machine-readable storage medium of claim 19, wherein the list of adjacent available base stations includes congestion information for the available base stations.
